(19) United States
(12) Patent Application Publication
(10) Pub. No.: US 2009/0228156 A1
(43) Pub. Date: Sep. 10, 2009

(54) CLOTHES REFRESHING APPARATUS AND METHOD FOR CONTROLLING THE SAME

(76) Inventors: Sog-Kie Hong, Seoul (KR); Dong-Won Kim, Gwangmyeong-si (KR)

Correspondence Address: KED & ASSOCIATES, LLP, P.O. Box 221200, Chantilly, VA, 20153-1200, US

(21) Appl. No.: 12/159,938

(22) PCT Filed: Apr. 18, 2007
(86) PCT No.: PCT/KR07/01876

§ 371 Date: Feb. 17, 2009

(30) Foreign Application Priority Data
May 15, 2006 (KR) 10-2006-0043405

(51) Int. Cl. D06F 37/00; G05D 23/19

(52) U.S. Cl. 700/300; 68/5 C

(57) ABSTRACT

A fabric refreshing apparatus is provided. The fabric refreshing apparatus includes a case, and a door that selectively opens and closes the case. A receiving compartment may be formed in the case receive fabric articles. A refreshing apparatus coupled to the receiving compartment may include a steam generator that supplies steam to the fabric articles in the receiving compartment, and a heater that heats the case to reduce condensation in the case.

This application claims the benefit of Korean Patent Application No. 10-2006-0043405 filed in Korea on May 15, 2006, the entirety of which is incorporated herein by reference.

### FIELD

This relates to a fabric refreshing apparatus.

### BACKGROUND

A refreshing apparatus is an electric appliance that has a refreshing function for removing smells or wrinkles from fabric articles stored therein by using steam and hot air. Since odor particles and wrinkles are removed by using the refreshing function, fabric articles in the refreshing apparatus may look as if they are freshly ironed.

A refreshing apparatus may use a condensing method or a discharging method based on a selected refreshing function. Specifically, the condensing method circulates steam inside the refreshing apparatus. The discharging method refreshes the fabric articles by using steam and then discharges the steam.

The refreshing apparatus includes an inner case for forming a receiving compartment, and a steam generator for generating steam. The steam generator includes a heater. An additional water supplying line or a water tank is connected to the steam generator for supplying water. The supplied water is heated by the heater and then is changed into steam. The steam is supplied into the receiving compartment to remove smell particles or wrinkles of the clothes therein.

### SUMMARY

Accordingly, a clothes refreshing apparatus and a method for controlling the same that substantially obviate one or more problems due to limitations and disadvantages of the related art are disclosed herein.

An object is to provide a refreshing apparatus that prevents steam from being condensed during a refreshing process and a method for controlling the same.

Another object is to provide a refreshing apparatus including a slim external appearance.

Additional advantages, objects, and features will be set forth in part in the description which follows and in part will become apparent to those having ordinary skill in the art upon examination of the following or may be learned from practice. The objectives and other advantages may be realized and attained by the structure particularly pointed out in the written description and claims hereof as well as the appended drawings.

To achieve these objects and other advantages and in accordance with embodiments as broadly described herein, there is provided a refreshing apparatus including: a case; a door selectively opening or closing the case; a receiving compartment formed in the case and receiving fabric articles; a steam generator supplying steam to the receiving compartment; and a heater heating an upper space of the case to prevent steam from being condensed, the steam being supplied into the case.

In another embodiment, there is provided a refreshing apparatus including: a main body formed of an external case and an inner case, and having a receiving compartment in the body; a door installed on a front of the main body to be rotatable; a heater installed on an inner side of the main body to prevent steam from being condensed; and a refreshing unit supplying steam or hot air into the receiving compartment.

In another embodiment, there is provided a method of controlling a refreshing apparatus, the method including: turning on a heater to prevent steam from being condensed in a receiving compartment, the steam being supplied during a refreshing process; detecting temperature around a heater installed portion by using a temperature sensor; and turning on or off the heater according to the detected temperature.

In a refreshing apparatus and a method for controlling the same as embodied and broadly described herein, a condensed water can be prevented, which is formed on the inner circumference of a receiving space or the inner circumference of a door in the refreshing apparatus during a refreshing process.

Additionally, since condensed water does not occur in a receiving space, dry efficiency for clothes improves and a major cause for bacterial propagation can be removed.

Moreover, since a plate-type heater is provided in the refreshing apparatus, a receiving space expands and the external appearance of the refreshing apparatus becomes slim.

Additionally, according to a refreshing apparatus and a method for controlling the same, since turning on or off of a plate-type heater is performed at an appropriate point, durability of the heater improves and power consumption reduces.

It is to be understood that both the foregoing general description and the following detailed description are exemplary and explanatory and are intended to provide further explanation of the embodiments as claimed.

### BRIEF DESCRIPTION OF THE DRAWINGS

FIG. 1 is a perspective view of a refreshing apparatus according to an embodiment as broadly described herein;

FIG. 2 is a cutaway perspective view of a rear structure of the refreshing apparatus shown in FIG. 1;

FIG. 3 is a partial sectional view taken along line I-I′ of FIG. 1;

FIG. 4 is a perspective view of a refreshing unit for a refreshing apparatus as embodied and broadly described herein;

FIG. 5 is an exploded perspective view of the refreshing unit shown in FIG. 4;

FIG. 6 is a schematic fluid flow diagram for the refreshing unit shown in FIGS. 4-5;

FIG. 7 is a sectional view of a plate-type heater installation according to an embodiment as broadly described herein;

FIG. 8 is a sectional view of a plate-type heater installation according to another embodiment as broadly described herein;

FIG. 9 is a flowchart of a refreshing process for a refreshing apparatus as embodied and broadly described herein;

FIG. 10 is a graph of temperature T versus time t in a receiving compartment during a refreshing process;

FIG. 11 is a flowchart of a process for controlling a plate-type heater during a steam supplying process;

FIG. 12 is a flowchart of a process for controlling a plate-type heater; and

FIG. 13 is a flowchart of a process for controlling a plate-type heater.

### DETAILED DESCRIPTION

Reference will now be made in detail to the embodiments, examples of which are illustrated in the accompanying drawings. Wherever possible, the same reference numbers will be used throughout the drawings to refer to the same or like parts.

A specific embodiment will be described based on a condensing type of apparatus, but embodiments are not limited to a condensing type and may be applied to a discharging type.

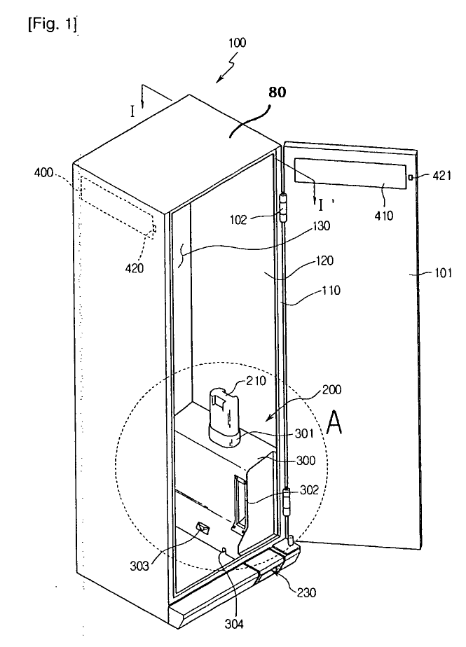

FIG. 1 is a front perspective view of a refreshing apparatus.

Referring to FIG. 1, a refreshing apparatus 100 includes a main body 80 providing a receiving compartment 130 therein, a door 101 rotatably mounted on the front of the main body 80, and a refreshing unit 200 disposed on one side of the main body 80 to provide steam and hot air to the receiving compartment 130. Specifically, the main body 80 includes an external case 110 forming an external appearance and an internal case 120 disposed inside the external case 110. The external case 110 and the internal case 120 are spaced a predetermined interval apart from each other. A heat insulator may be inserted in the space between the external case 110 and the internal case 120 to minimize heat exchange between the receiving compartment 130 and the outside. Hereinafter, a structure with an insulator will be described. A shelf for stacking fabric articles or a hanger for hanging fabric articles may be provided in the receiving compartment 130.

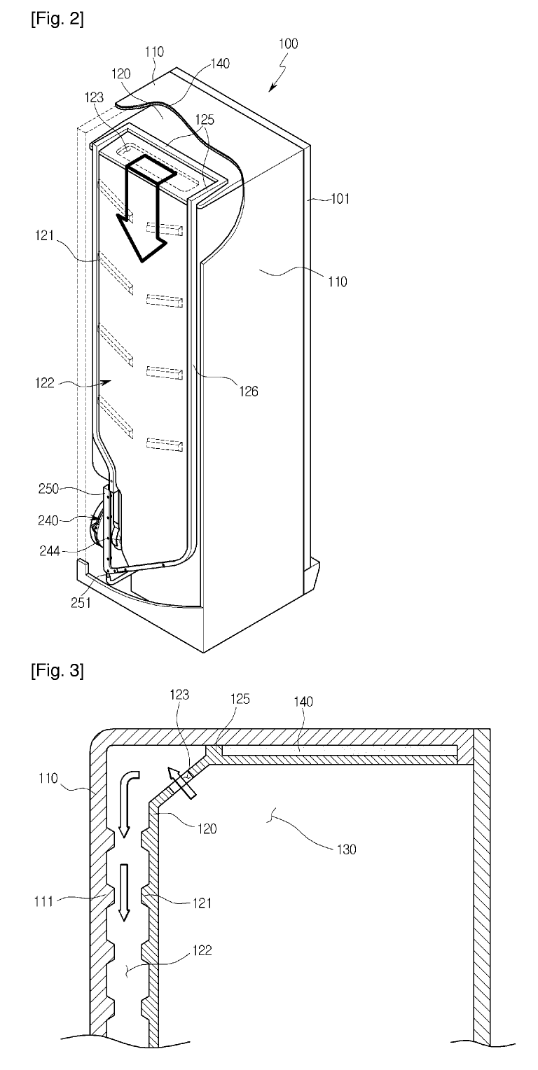

The refreshing unit 200 in the refreshing apparatus 100 is disposed on the side bottom of the main body 80. In the embodiment shown in FIGS. 1-2, a portion of the side of the inner case 120 is recessed toward the receiving compartment 130, and thus a mechanical room 300 is formed that is spaced apart from the external case 110. The refreshing unit 200 is received in the mechanical room 300. A water tank 210 is disposed on the side of the inner case 120 forming the mechanical room 300. A discharge port 302 for discharging dry air, a steam discharge port 303 for discharging steam, and a drain hole 304 for draining a condensed water falling down to the bottom of the receiving compartment 130 are disposed on the side of the inner case 120 forming the mechanical room 300. The water tank 210 is inserted into a support sleeve 301 that protrudes in a cylindrical shape from the inner case 120. In the embodiment shown in FIGS. 1-2, a drain tank 230 is provided at the bottom of the mechanical room 300 to collect condensed water, with the front of the drain tank 230 exposed at the front bottom of the refreshing apparatus 100 so that a user can withdraw the drain tank 230 from the front of the refreshing apparatus 100.

Additionally, the door 101 is rotatably attached to one side edge of the main body 80 by a hinge 102.

Heaters such as plate-type heaters 400 and 410 are mounted on the side of the inner case 120 and the inner surface of the door 101. Temperature sensors 420 and 421 are mounted near the plate-type heaters 400 and 410. This upper portion of the inner case 120 is a place where a portion of supplied steam is easily condensed. The heaters 400 and 410 and sensors 420 and 421 are installed to remove the condensation phenomenon. More specifically, the temperature sensors 420 and 421 sense temperature near the heaters 400 and 410, and turn the heaters 400 and 410 on or off. Description related to this will be made in more detail with reference to the drawings.

Additionally, a condensing unit 122 as shown in FIG. 2 is provided at the rear of the main body 80. The condensing unit 122 receives and condenses steam from the receiving compartment 130. Description for this will be described with reference to the drawings.

FIG. 2 is a cutaway perspective view of a rear structure of a refreshing apparatus, and FIG. 3 is a partial sectional view taken along line I-I′ of FIG. 1.

Referring to FIGS. 2 and 3, a structure for condensing steam is provided at the rear of the main body 80 in the refreshing apparatus 100. Specifically, a condensing unit 122, where steam and air descend, is formed between the inner rear surface of the external case 110 and the outer rear surface of the internal case 120. A steam discharge port 123 is formed at an upper rear portion of the inner case 120 to discharge steam from receiving compartment 130 into the condensing unit 122.

More specifically, the upper rear portion of the inner case 120 having the steam discharge port 123 is slanted toward the bottom of the refreshing apparatus 100 at a predetermined angle such that the discharged steam smoothly flows into the condensing unit 122.

Here, the steam is in a vapor state and easily ascends toward the top of the receiving compartment 130. Therefore, the steam discharge port 123 may be formed at the top of the refreshing apparatus 100.

A partition wall 125 is horizontally formed at the top of the inner case 120, and prevents the steam discharged though the steam discharge port 123 from flowing toward the front of the main body 80.

Guide ribs 126 extend from opposite ends of the partition wall 125 towards the rear of the inner case 120. Specifically, the guide ribs 126 guide steam discharged through the steam discharge port 123 to smoothly descend toward the bottom of the condensing unit 122. The top of the partition wall 125 and the guide ribs 126 closely contact the external case 110, thereby preventing the steam from leaking to the outside.

The steam flowing into the condensing unit 122 through the steam discharge unit 123 falls from the top to the bottom of the condensing unit 122 and is condensed. Since the steam is in a high temperature vapor state, the steam exchanges heat with external air by conducting heat through the external case 110. To improve heat conductivity efficiency, a plurality of condensation pins 111 are arranged on the inner surface of the external case 110. The condensation pins 111 may be formed when a corresponding portion of the external case 110 is recessed toward the inside, or when the outer surface of the external case 110 is flat and its inner surface protrudes through a forming process. The size of a heat exchange area is increased due to the condensation pins 111 and a condensation path is lengthened. Condensation pins 121 similar to the condensation pins 111 formed on the external case 110 may be formed on the inner case 120.

The condensation pins 111 and 121 are formed slanted toward the bottom of the main body 80, and arranged alternately on the left and right of the main body 80. Since a path through which the steam descends has a zigzag shape due to the condensation pins 111 and 121, a condensation path formed therebetveen is longer compared to a straight line shape. Since the condensation path is longer, a heat exchange area and time is longer.

The condensing unit 122 has a shape in which the steam is concentrated to one point at the bottom due to the guide ribs 126.

Specifically, the bottom of the guide rib 126 is formed curved toward the edge of one side of the internal case 120. Two guide ribs 126 extend from opposite ends of the partition wall 125 toward the bottom and meet each other at the edge of the inner case 120. A condensed water discharge port 251 is formed at the point where the guide ribs 126 meet each other. The condensed water discharge port 251 is connected to the drain tank 230 through a hose. A guide duct 250 is provided near the point where the two guide ribs 126 meet to guide the descending steam toward a drying duct 240 that leads back into the refreshing unit 200. A suction port 244 of the drying duct 240 is connected to the guide duct 250 such that a portion of the steam flows into the drying duct 240 during a steam supplying process. The suction port 244 is a path where dry air circulates during a drying process. Structures and functions of the drying duct 240 and the guide duct 250 will be described in more detail with reference to the drawings.

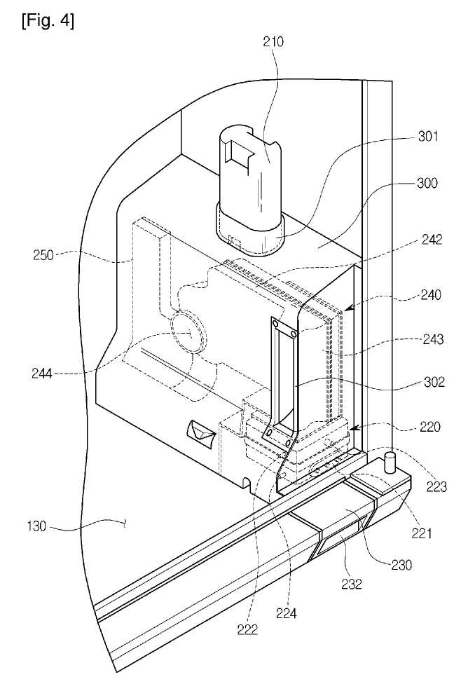

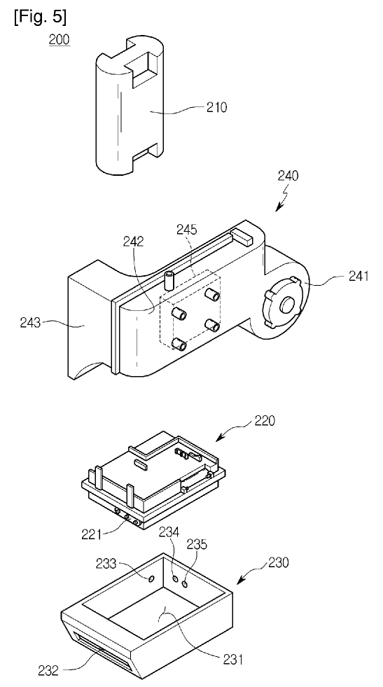

FIG. 4 is a partial perspective view of a refreshing unit is mounted on a refreshing apparatus, and FIG. 5 is an exploded perspective view of the refreshing unit.

Referring to FIGS. 4 and 5, the refreshing unit 200 includes a water tank 210 supplying water for generating steam, a steam generator 220 generating steam with the water from the water tank 210, a drain tank 230 collecting remaining water in the water tank 210 and the steam generator 220 and condensed water generated during a steam supplying process, and a drying duct 240 supplying high temperature air during a drying process. The refreshing unit 200 is received in the mechanical room 300.

Specifically, the water tank 210 stores a predetermined amount of water therein and supplies the water to the steam generator 220. The water tank 210 is removably received in a support sleeve 301 of the case 240. Accordingly, when the water stored in the water tank 210 is depleted, the water tank 210 can be easily separated for re-supplying.

The steam generator 220 receives water from the water tank 210 to generate steam. Specifically, the steam generator 220 includes a heater 221 to change the water into the steam by using heat generated from the heater 221. The water is supplied from the water tank 210 to the steam generator 220 through a predetermined supply path, i.e., a hose. Additionally, a water supply port 223 connected to the water tank 210 through the hose, a steam discharge port 222 for discharging the steam, and a drain port 224 for draining the remaining water are formed on one side of the steam generator 220, respectively. In the embodiment shown in FIGS. 4-5, the water supply port 223 and the steam discharge port 222 are provided on the top of the steam generator 220. The drain port 224 is provided on the bottom of the steam generator 220.

The drain tank 230 is a place where the remaining water in the steam generator 220, condensed water in the condensing unit 122, and the condensed water falling to the bottom of the refreshing compartment 130 is collected. The condensed water is collected in the drain tank 230 along the drain path such as a hose.

The drain tank 230 includes a first connection port 233 connected to the drain port 224 of the steam generator 220, a second connection port 234 connected to a drain hole 304 in the bottom of the refreshing compartment 130, and a third connection port 235 connected to a condensed water discharge port 251 provided at the lower portion of the condensing unit 122. In other methods, a cluster is separately provided to collect the water drained through the steam generator 220 and the drain hole 304, and the cluster is connected to the drain tank 230 through the hose. An additional connection port that directly connects the water tank 210 and the drain tank 230 may be further formed on one side of the drain tank 230 or the clusters.

Bacterial proliferation occurs when water remains stagnant for a long period of time in a storage chamber 231 of the drain tank 230. Furthermore, a portion of the polluted water in the drain tank 230 may be vaporized and then delivered into the receiving compartment 130 during a subsequent refreshing process. Accordingly, the drain tank 230 may be emptied after a predetermined time or periodically.

To satisfy these needs, the drain tank 230 may be mounted on the main body 80 at the bottom of the refreshing apparatus 100 as a drawer type tank. Then, the drain tank 230 can be easily detached and emptied. A grip groove 232 is formed on the front of the drain tank 230 such that the drain tank 230 can be easily withdrawn.

The drying duct 240 heats and circulates air inside the refreshing compartment 130. Specifically, the drying duct 240 includes a fan installation unit 241 for providing a drying fan, a heater installation unit 242 having a drying heater 245, and a discharge unit 243 discharging high temperature air. The discharge unit 243 is connected to the discharge port 302 formed on the side of the inner case 120 constituting the mechanical room 300. A suction port 244 is formed on the front of the fan installation unit 241, and the suction port 244 is connected to the guide duct 250.

According to the above structure, when the drying fan 241 and the drying heater 245 in the drying duct 240 operate, air in the refreshing apparatus 130 is discharged through the steam discharge port 123 formed at the top of the inner case 120. The discharged air descends along the condensing unit 122 and flows into the guide duct 250. The air is suctioned into the drying duct 240 thorough the suction port 244 of the drying duct 240. The suctioned air is heated to a high temperature by using the drying heater 245. Then, an air circulating process is repeated, so that the heated air is discharged into the receiving compartment 130 again through the discharge unit 243 and the discharge port 302.

In the embodiment shown in FIGS. 4-5, the water tank 210, the steam generator 220, and the drain tank 230 are sequentially stacked. Due to this stacked structure, space that the mechanical room 300 occupies is reduced and available space in the receiving compartment 130 is increased.

Additionally, according to above-stacked structure, the flow of water in the refreshing unit 200 falls naturally by means of gravity. Accordingly, an additional device is not required for generating the flow of water in the refreshing unit 200. Furthermore, the overall size of the refreshing unit 200 is reduced.

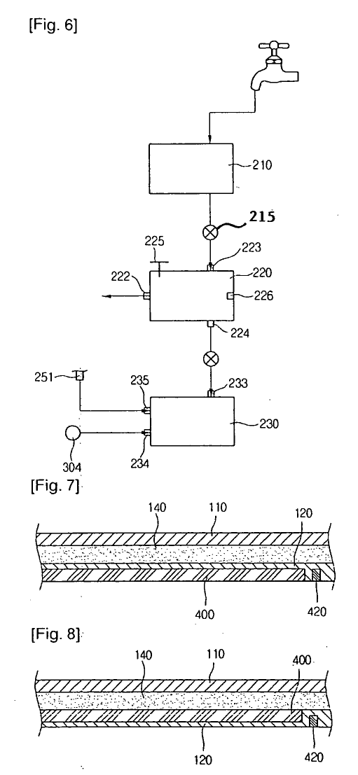

FIG. 6 is a schematic fluid flow diagram in which the remaining water in the water tank 210 is collected into the drain tank 230 through the steam generator 220. This will be described in more detail.

Referring to FIG. 6, water is supplied from a water supplying source to the water tank 210, and the supplied water is supplied to the steam generator 220. A control valve 215 is mounted between the water tank 210 and the steam generator 220. A water level sensor 225 is installed inside the steam generator 220 such an appropriate amount of water can be supplied to the steam generator 220. Although not illustrated, the control valve 215 may instead be installed on a path connecting the water supplying source and the water tank 210, and the water level sensor 225 may be mounted inside the water tank 210. Additionally, a temperature sensor 226 is mounted inside the steam generator 220 thereby preventing the steam generator 220 from being overheated if the heater 245 continuously operates without sufficient water. The drain port 224 of the steam generator 220 and the first connection port 223 of the drain tank 230 are connected to each other through a hose.

According to the above structure, the water stored in the water tank 210 is supplied to the steam generator 220 through the water supply port 223. The supplied water is heated and the steam is generated by operation of the heater 221 inserted in the steam generator 220. The generated steam is discharged into the receiving compartment 130 through the steam discharge ports 222 and 303.

Once the steam supplying process is completed, the remaining water in the steam generator 220 is discharged through the drain port 224. The drained water is stored in the storage chamber 231 through the first connection port 233 of the drain tank 230.

Condensed water is discharged through the condensed water discharge port 251 during a steam supplying process. The condensed water is formed when a portion of the steam falls along the condensing unit 122. The discharged condensed water is collected in the storage chamber 231 through the third connection port 235 of the drain tank 230. Then, a user can withdraw the drain tank 230 for disposal of the collected water.

FIG. 7 is a sectional view of a plate-type heater installation according to a first embodiment.

Referring to FIG. 7, the main body 80 of the clothes refreshing apparatus 100 includes an external case 110, an inner case 120 in the external case 110, and a heat insulator 140 disposed between the inner case 120 and the external case 110. The heat insulator 140 can be applied according to products. The plate-type heater 400 can be mounted so that it is exposed to the inner surface of the inner case 120, i.e., the receiving compartment 130.

Specifically, the plate-type heater 400 may be mounted on the side top of the inner case 120 or on the ceiling of the inner case 120.

More specifically, the plate-type heater 400 is disposed on the inner surface of the inner case 120 and is mounted to be level with the inner surface of the inner case 120. When the plate-type heater 400 is installed, the thickness of the inner case 120 is minimized. Therefore, the slimness of the main body 80 can be achieved.

Moreover, since the plate-type heater 400 is installed on the inner surface of the inner case 120 in the receiving compartment 130, moisture condensation can be directly prevented. Accordingly, the preventing of the moisture condensation can be more easily achieved.

A temperature sensor 420 is mounted on the side of the plate-type heater 400. That is, a predetermined temperature is maintained without overheating the inner case 120 by detecting the temperature of the inner case 120 through the temperature sensor 420. Then, the temperature sensor 420 may be installed in the inner case 120, which is similar to the plate-type heater 400.

According to this embodiment, although only the plate-type heater 400 and the temperature sensor 420 in the inner case 120 are described, this can be identically applied to the plate-type heater 410 and the temperature sensor 421 in the rear of the door 101.

FIG. 8 is a sectional view of a plate-type heater installation according to a second embodiment.

Referring to FIG. 8, the plate-type heater 410 is recessed and mounted on the rear of the inner case 120.

Specifically, since the plate-type heater 400 is installed on the rear of the inner case 120, the front of the inner case 120 may have a neat appearance. Moreover, moisture cannot penetrate through an interface between the plate-type heater 400 and the inner case 120 such that malfunction of the plate-type heater 400 can be prevented. Since the heat insulator 140 is inserted between the external case 110 and the inner case 120, the heat from the plate-type heater 400 does not leak toward the outside.

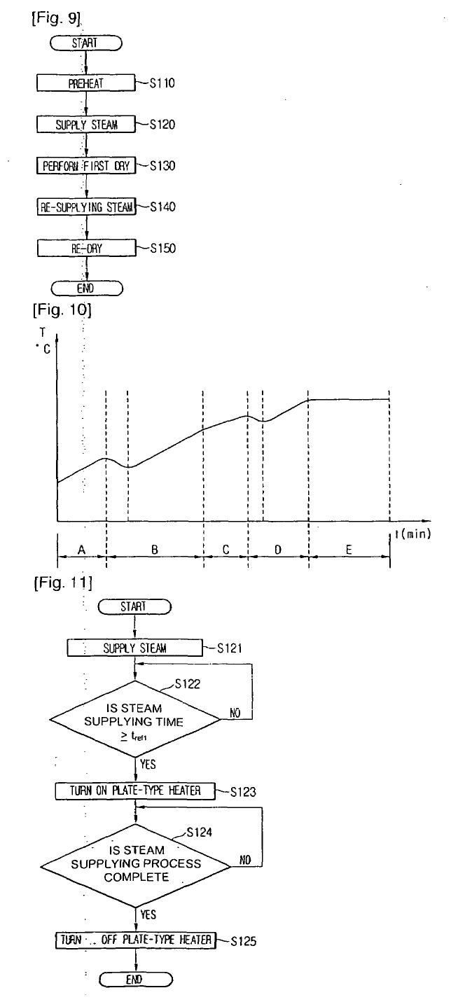

FIG. 9 is a flowchart illustrating a refreshing process in a refreshing apparatus as embodied and broadly described herein.

Referring to FIG. 9, once a clothes refreshing process begins, a preheating process is performed to heat the inside of the receiving compartment to a predetermined temperature in operation S110. This is illustrated in a section A of FIG. 10. Specifically, the preheating process is a preliminary process that heats the receiving compartment 130 to an appropriate temperature before supplying steam, thereby minimizing steam condensation.

When the preheating process is completed and the receiving compartment 130 reaches the predetermined temperature, a steam supplying process is performed in operation S120. This is illustrated in a section B of FIG. 10.

In the steam supplying process, a heating process for heating water that is supplied into the steam generator 220 and a steam injecting process for injecting the generated steam into the receiving compartment 130 are performed continuously. Specifically, the temperature of the receiving compartment 130 rises again during time for heating water to generate steam. When a steam supplying time reaches a predetermined time, the steam supplying process is terminated and then the next process is performed. During the steam supplying process, a portion of the water in the steam generator 220 is converted into steam and then supplied.

After the steam supplying process is complete, a first drying process is performed in operation S130, and this is illustrated in a section C of FIG. 10.

Specifically, the first drying process removes moisture from the fabric articles and humidity from the receiving compartment 130 generated during the steam supplying process, thereby removing smells and wrinkles from the fabric articles.

Once the first drying process begins, the drying duct 240 operates, and then air heated by the drying heater 245 circulates in the receiving compartment 130 and the condensing unit 122. An inner temperature of the receiving compartment 130 rises due to a high temperature air that is supplied into the receiving compartment 130.

When the first drying process is completed, a steam re-supplying process is performed in operation S140, and this is illustrated in a section D of FIG. 10.

Specifically, the remaining water in the steam generator 220 is re-heated and is supplied into the inside of the receiving compartment 130 during the steam re-supplying process in operation S140. During the steam re-supplying process, since the receiving compartment 130 is already heated to a high temperature, an amount of condensation generated is less than that of the steam supplying process S120. During the steam re-supplying process, an inner temperature of the receiving compartment 130 falls temporarily and rises again when the water is heated.

During the steam re-supplying process, all the remaining water in the steam generator 220 is converted into steam and then supplied into the receiving compartment 130.

Once the steam re-supplying process is completed, a re-drying process is performed in operation S150, and this is illustrated in section E of FIG. 10.

In the re-drying process, since an inner temperature of the receiving compartment 130 is heated close to that of hot air from the drying duct 240, a temperature rise in the receiving compartment 130 is relatively weak.

When the re-drying process is terminated, all the processes for refreshing the fabric articles are completed, and then a draining process is performed. According to a user selection, a user can dump the water in the storage chamber 231 after withdrawing the drain tank 230.

Power is applied to the drying duct 240 during the first drying process S130 and the re-drying process S150, such that air in the condensing unit 122 flows into the drying duct 240. The air is heated by the drying heater 245 of the drying duct 240, is converted into hot air, and then is discharged through the discharge ports 243 and 302. The discharged hot air dries the fabric articles in the receiving compartment 130.

Additionally, the water supplied to the supply tank 210 is supplied into the steam generator 220 during the steam supplying process S120 and the steam re-supplying process S140. The supplied water is heated by the heater 221 of the steam generator 220 to generate high temperature steam. The generated steam is supplied into the receiving compartment 130 through the team discharge ports 222 and 303.

A portion of the steam supplied to the receiving compartment 130 penetrates into the fabric articles, and the other portion flows into the condensing unit 122 through the steam discharge port 123. The flowing steam passes through the condensing unit 122 and exchanges heat with external air using the rear of the external case 122 as a heat exchanging layer. During this process, the temperature of the steam rises and then condensation is generated. The generated condensed water falls along the condensation pins 111 and 121, through the condensed water discharge port 251 and into the drain tank 230.

FIG. 11 is a flowchart illustrating a process for controlling a plate-type heater during a steam supplying process.

Referring to FIG. 11, the plate-type heater operates during the steam supplying process, thereby preventing water from being condensed on the top of the inner case 120.

Specifically, once steam is supplied in operation S121, a controller detects a steam supplying time. In operation S122, it is determined whether or not the detected steam supplying time has reached a predetermined time Tref₁. When the detected steam supplying time reaches the predetermined time Tref₁, the plate-type heater is turned on in operation S123. Then, it is determined whether or not the steam supplying process is completed in operation S124. When the steam supplying process is finished, the plate-type heater is turned off in operation S125. According to the above controlling method, condensed water in the receiving compartment 130 can be prevented before supplying the steam into the condensing unit 122.

In certain instances, after one or two minutes have passed since the initiation of steam being supplied to the receiving compartment 130, steam may be condensed on the inner surface of the inner case 120. Accordingly, the predetermined time Tref₁ may be set to one or two minutes.

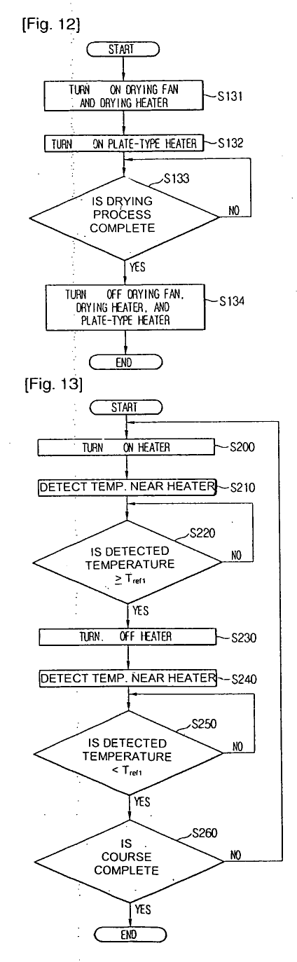

FIG. 12 is a flowchart illustrating a process for controlling a plate-type heater.

Referring to FIG. 12, once the first drying and re-drying processes begin, the drying fan 241 and the drying heater 245 are turned on in operation S131, and the plate-type heater is simultaneously turned on in operation S132. In operation S133, it is determined whether or not the drying is completed. When the drying is completed, the drying fan 241, the drying heater 245, and the plate-type heater are all turned off in operation S134.

Since the plate-type heater is simultaneously turned on during the drying process, an inner temperature of the receiving compartment 130 reaches the predetermined temperature promptly, thereby reducing a drying time for the fabric articles and the receiving compartment 130.

FIG. 13 is a flowchart illustrating another process for controlling a plate-type heater.

Referring to FIG. 13, the plate-type heater is appropriately turned on or off according to a surface temperature of the inner case 120, in order to prevent overheating and heat damage.

Specifically, when the plate-type heaters 400 and 410 are turned on during the drying process or the steam supplying process in operation S200, the temperature near the heater installation region is detected by the temperature sensors 420 and 421 mounted on one side of the inner case 120 in operation S210. Here, the temperature around the heater installation region is the temperature of the surface of the inner case around an area where the plate-type heater is mounted.

More specifically, it is determined whether or not the temperature detected by the temperature sensors 420 and 421 is greater than the predetermined temperature Tref₁ in operation S220. When the detected temperature is higher than the predetermined temperature Tref₁, the plate-type heater 400/410 is turned off in operation S230. The temperature sensor 420/421 continuously detects the temperature around the heater installation region in operation S240, and then it is determined whether or not the detected temperature is below the predetermined temperature Tref₁ in operation S250. When the detected temperature is below the predetermined temperature Tref₁, it is determined whether or not a corresponding course is completed in operation S260. When the corresponding course is completed, a process of controlling the plate-type heater is completed. Contrarily, when the corresponding course is still in progress, the above process is repeated.

According to the above controlling method, the temperature of the inner case with the plate-type heater is maintained at the predetermined temperature Tref₁, thereby preventing condensed water from being generated and simultaneously preventing the heater from being overheated.

It will be apparent to those skilled in the art that various modifications and variations can be made in the embodiments as broadly described herein. Thus, it is intended that the present invention covers the modifications and variations of this invention provided they come within the scope of the appended claims and their equivalents.

In a refreshing apparatus and a method for controlling the same as embodied and broadly described herein, condensed water can be prevented from forming on the inner circumference of a receiving space or the inner circumference of a door in the refreshing apparatus during a refreshing process.

1-20. (canceled)

21. A fabric refreshing apparatus, comprising:
a case;
a door configured to selectively open or close the case;
a receiving compartment formed in the case;
a steam generator configured to supply steam to the receiving compartment; and
a heater configured to heat a portion of the case so as to increase a temperature of a corresponding surface of the receiving compartment.

22. The apparatus of claim 21, wherein the heater is provided with one of the case or the door.

23. The apparatus of claim 21, wherein the heater comprises a plate-type heater installed in a recess in an interior surface of one of the case or the door such that an exposed surface of the heater is level with the interior surface of the one of the case or the door.

24. The apparatus of claim 21, further comprising a temperature sensor installed proximate the heater, wherein the temperature sensor is configured to detect a temperature in a portion of the case where the heater is installed.

25. The apparatus of claim 24, wherein the heater is turned on or off based on a temperature detected by the temperature sensor.

26. The apparatus of claim 21, further comprising a drying duct, a fluid supply and a drain, wherein the drying duct is configured to supply hot air into the receiving compartment, the fluid supply is configured to supply fluid to the steam generator, and the drain is configured to collect condensed fluid generated during a refreshing operation and residual fluid from the steam generator.

27. The apparatus of claim 21, wherein the heater comprises a plate-type heater installed in a recess formed in one of the case or the door.

28. The apparatus of claim 27, wherein an exposed surface of the heater is substantially coplanar with a corresponding surface of the one or the case or the door in which the recess is formed.

29. The apparatus of claim 27, wherein the case comprises an internal case provided in an external case, wherein the recess is formed in an external surface of the internal case such that an exposed surface of the heater is substantially coplanar with the external surface of the internal case and an internal surface of the internal case separates the heater from the receiving compartment.

30. The apparatus of claim 21, wherein the heater is installed on an interior surface of one of the case or the door.

31. The apparatus of claim 30, wherein the heater comprises a plate-type heater installed on an upper portion of the one of the case or the door.

32. The apparatus of claim 21, wherein the case comprises an internal case provided in an external case, and wherein the heater is installed on an external surface of the internal case.

33. A fabric refreshing apparatus, comprising:
a main body comprising an external case and an internal case provided in the external case;
a door rotatably coupled to the main body;
a heater installed on an inner surface of the main body and configured to heat the receiving compartment; and
a refreshing unit configured to selectively supply steam and hot air to the receiving compartment.

34. The apparatus of claim 33, wherein the receiving compartment has a first end and a second end, and wherein the refreshing unit is provided at the first end and the heater is provided at the second end.

35. The apparatus of claim 33, wherein the heater is installed on an internal surface or an external surface of the receiving compartment.

36. The apparatus of claim 33, wherein the heater is installed in a recess formed in one of an inner surface or an outer surface of the internal case.

37. The apparatus of claim 36, wherein the heater is a plate-type heater, and wherein an exposed surface of the heater installed in the recess is level with the one of the inner surface or the outer surface of the internal case.

38. The apparatus of claim 33, wherein the heater is installed in one of a side or a ceiling of the internal case.

39. The apparatus of claim 33, further comprising an auxiliary heater installed in a recess formed in a rear surface of the door.

40. The apparatus of claim 33, further comprising at least one temperature sensor provided proximate at least one of the heater or the auxiliary heater, wherein the at least one temperature sensor is configured to sense a temperature in the receiving compartment.

41. The apparatus of claim 33, wherein the heater is installed in an upper portion of the main body.

42. The apparatus of claim 33, further comprising an insulator provided between the internal case and the external case.

43. A method for controlling a fabric refreshing apparatus, the method comprising:
turning on a heater installed in a surface of a receiving compartment to increase a temperature of the receiving compartment;
detecting a temperature proximate the heater using a temperature sensor; and
turning the heater off or leaving the heater on based on the detected temperature.

44. The method of claim 43, further comprising performing a refreshing operation, comprising:
preheating the receiving compartment to a predetermined temperature;
supplying steam to the receiving compartment; and
supplying dry air to the receiving compartment.

45. The method of claim 44, wherein preheating the receiving compartment comprises preheating an upper portion of the receiving compartment.

46. The method of claim 44, wherein the heater is turned on or off during at least one of the preheating process, the steam supplying process or the drying process to increase a temperature of the corresponding surface of the receiving compartment.

47. The method of claim 46, wherein turning on the heater comprises turning on the heater after a predetermined time has elapsed since initiating the steam supplying process.

48. The method of claim 46, further comprising turning the heater off when the at least one of the preheating process, the steam supplying process or the drying process is completed.

49. The method of claim 46, wherein the heater is turned on at the beginning of the steam supplying process or the drying process.

50. The method of claim 43, wherein turning on a heater installed in a surface of a receiving compartment to increase a temperature of the receiving compartment comprises turning on a heater installed in an upper portion of the receiving compartment to increase a temperature of the upper portion of the receiving compartment.
